(19) United States
(12) Patent Application Publication
(10) Pub. No.: US 2008/0174808 A1
(43) Pub. Date: Jul. 24, 2008

(54) SYSTEM AND METHOD FOR JOB SUBMISSION TO AN UNSPECIFIED DOCUMENT PROCESSING DEVICE

(76) Inventors: Harpreet Singh, Orange, CA (US); Ken Stephenson, San Clemente, CA (US); Marianne Kodimer, Huntington Beach, CA (US); Louis Ormond, Irvine, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/626,814

(22) Filed: Jan. 24, 2007

(51) Int. Cl. G06F 15/00

(52) U.S. Cl. 358/1.15

(57) ABSTRACT

The subject application is directed to a system and method for routing electronic documents to an unspecified document processing device. An electronic document is first routed to a document processing queue via a computer network. The queue is further accessible by multiple document processing devices via the network. A job processing request is then received from an associated user via a user interface associated with a selected document processing device. The request includes an instruction from the user to commence processing of the electronic document that is stored in the document processing queue. The job processing request is then communicated to the document processing queue for release to the selected device. The electronic document is then communicated to the selected document processing device. The cost is then calculated associated with the requested document processing operation and the operation is performed upon receipt of payment.

### BACKGROUND OF THE INVENTION

The subject application is directed to a system and method for submitting a document processing job to an unspecified document processing device. In particular, the subject application is directed to a system and method for remotely generating a document processing job, wherein the job is able to be retrieved from any available document processing service location or device.

A professional or other mobile user is routinely required to work with documents or other data while away from an office environment. Such a user needs to generate image data, by printing or scanning a document, and then needs to distribute or perform other functions on such image data. A user may access such document processing services via a document processing services provider. In some instances, the user will access the services remotely, transmitting a request for a document processing job to a selected document processing services location. The user must then travel to that particular document processing services location to obtain the document processing job. However, the selected location may not be able to process the job for a variety of reasons. For example, the selected device at the location is not functioning properly, the location is not open for business at the time the service was requested, or the selected type of operation is not available at such location, such as color printing. In addition, the user may not have the ability to travel to the selected location to retrieve the job. In such situations, the user would then have to resubmit the job to a location which is able to perform the requested service or to which the user has the ability to retrieve the job. It would be desirable to have a system and method wherein a user may retrieve a document processing job from any available document processing service location or device.

The subject application overcomes the above noted limitations and provides a system and method for submitting a document processing job to an unspecified document processing device.

### SUMMARY OF THE INVENTION

In accordance with the subject application, there is provided a system and method for submitting a document processing job to an unspecified document processing device.

Further, in accordance with the subject application, there is provided a system and method for remotely generating a document processing job, wherein the job is able to be retrieved from any available document processing service location or device.

Still further, in accordance with the subject application, there is provided a system for routing electronic documents to an unspecified document processing device. The system comprises means adapted for routing an electronic document to a document processing queue accessible by each of a plurality of document processing devices in network communication therewith. The system also comprises user interface means adapted for receiving a job processing request from an associated user to commence processing of the electronic document stored in the document processing queue at a document processing device selected from the plurality thereof. The system further comprises means adapted for communicating data representative of a received job processing request to commence a release of the electronic document from the document processing queue and means adapted for communicating the electronic document via an associated network to the selected document processing device upon receipt of a job processing request.

In one embodiment, the user interface means is comprised of a thin client on an associated networked data processing device.

In another embodiment, the user interface is associated with the selected document processing device.

In a further embodiment, the system further includes means adapted for receiving identifier data representative of an identity of the associated user and means adapted for generating document identifier data representative of the electronic document on the user interface.

In yet another embodiment, the system also includes means adapted for displaying, on the user interface, cost data associated with a cost of a document processing operation on the electronic document and means adapted for receiving payment data representative of a payment for the document processing operation. Such embodiment also includes means adapted for commencing processing of the electronic document on the selected document processing device upon receipt of payment data. Preferably, the payment data is obtained in accordance with a credit card swipe completed at the selected document processing device.

Still further, in accordance with the subject application, there is provided a method for routing electronic documents to an unspecified document processing device in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of the system for routing electronic documents to an unspecified document processing device according to the subject application;

FIG. 2 is a block diagram illustrating device hardware for use in the system for routing electronic documents to an unspecified document processing device according to the subject application;

FIG. 3 is a functional diagram illustrating the device for use in the system for routing electronic documents to an unspecified document processing device according to the subject application;

FIG. 4 is a block diagram illustrating server hardware for use in the system for routing electronic documents to an unspecified document processing device according to the subject application;

FIG. 5 is a flowchart illustrating a method for routing electronic documents to an unspecified document processing device according to the subject application;

FIG. 6 is a flowchart illustrating a method for routing electronic documents to an unspecified document processing device from a server point of view according to the subject application; and

FIG. 7 is a flowchart illustrating a method for routing electronic documents to an unspecified document processing device from a document processing device point of view according to the subject application.

### DETAILED DESCRIPTION OF THE PREFERRED EMBODIMENT

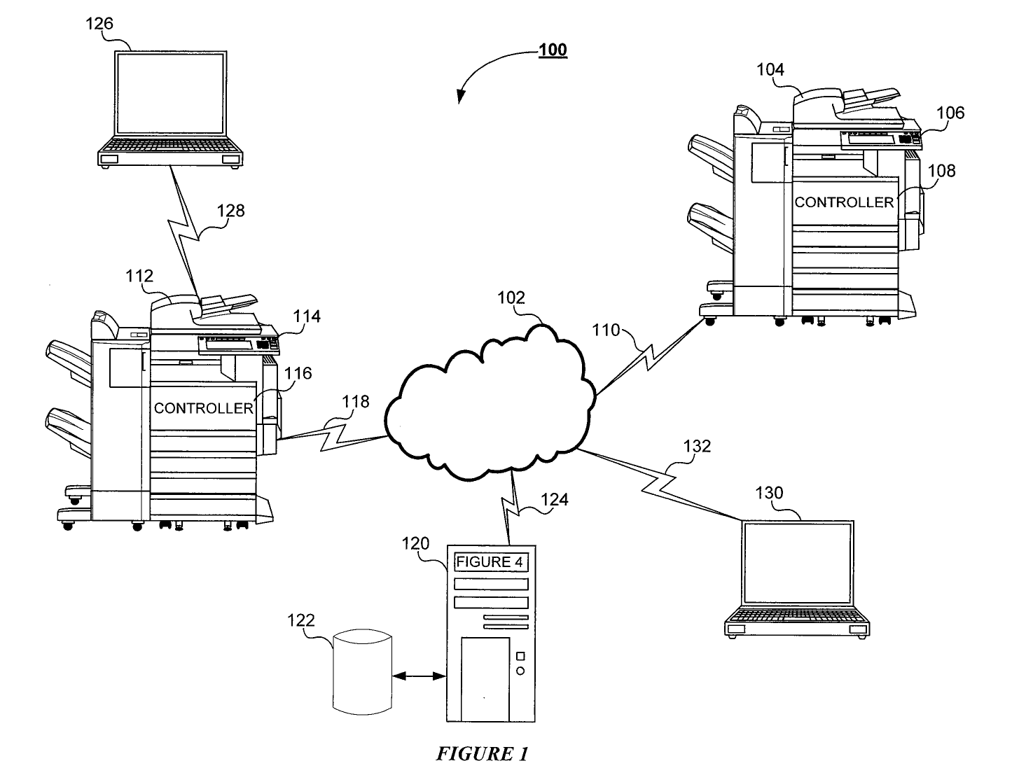

The subject application is directed to a system and method for submitting a document processing job to an unspecified document processing device. In particular, the subject application is directed to a system and method for remotely generating a document processing job, wherein the job is able to be retrieved from any available document processing service location or device. It will become apparent to those skilled in the art that the system and method described herein are suitably adapted to a plurality of varying electronic fields employing user interfaces, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of the system 100 for routing electronic documents to an unspecified document processing device in accordance with the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes at least one remote document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108. Preferably, the document processing device 104 is communicatively coupled to the computer network 102 via a suitable communications link 110. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

In accordance with the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for previewing document processing media of the subject application.

In accordance with one aspect of the subject application, the system 100 illustrated in FIG. 1 further includes a local document processing device 112, depicted as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. According to a preferred embodiment of the subject application, the document processing device 112 is suitably adapted to provide local document processing services to external devices, such as proximally located data processing devices. The skilled artisan will appreciate that the document processing device 112 is suitably capable of providing remote document processing services, as will be understood in the art. Preferably, the document processing device 112 includes hardware, software, and any suitable combination thereof, configured to interact with an associated user, a networked device, or the like.

According to one embodiment of the subject application, the document processing device 112 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 112 further includes an associated user interface 114, such as a touch-screen, LCD display, touch-panel, alpha-numeric keypad, or the like, via which an associated user is able to interact directly with the document processing device 112. In accordance with the preferred embodiment of the subject application, the user interface 114 is advantageously used to communicate information to the associated user and receive selections from the associated user. The skilled artisan will appreciate that the user interface 114 comprises various components, suitably adapted to present data to the associated user, as are known in the art. In accordance with one embodiment of the subject application, the user interface 114 comprises a display, suitably adapted to display one or more graphical elements, text data, images, or the like, to an associated user, receive input from the associated user, and communicate the same to a backend component, such as a controller 116. Preferably, the document processing device 112 is communicatively coupled to the computer network 102 via a suitable communications link 118. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

In accordance with the subject application, the document processing device 112 further incorporates a backend component, designated as the controller 116, suitably adapted to facilitate the operations of the document processing device 112, as will be understood by those skilled in the art. Preferably, the controller 116 is embodied as hardware, software, or any suitable combination thereof, configured to control the operations of the associated document processing device 112, facilitate the display of images via the user interface 114, direct the manipulation of electronic image data, and the like. For purposes of explanation, the controller 116 is used to refer to any myriad of components associated with the document processing device 112, including hardware, software, or combinations thereof, functioning to perform, cause to be performed, control, or otherwise direct the methodologies described hereinafter. It will be understood by those skilled in the art that the methodologies described with respect to the controller 116 are capable of being performed by any general purpose computing system, known in the art, and thus the controller 116 is representative of such a general computing device and is intended as such when used hereinafter. Furthermore, the use of the controller 116 hereinafter is for the example embodiment only, and other embodiments, which will be apparent to one skilled in the art, are capable of employing the system and method for previewing document processing media of the subject application.

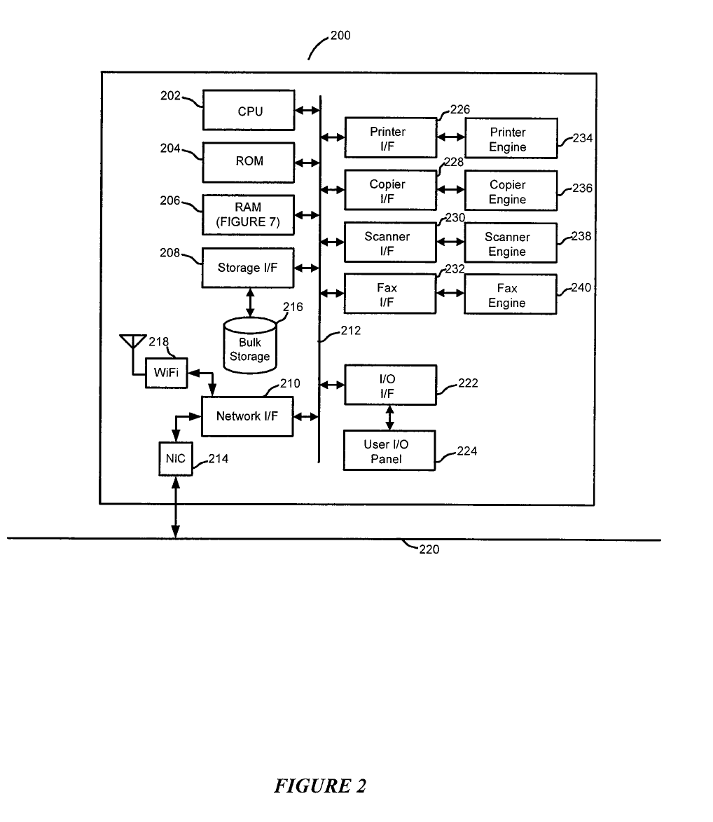

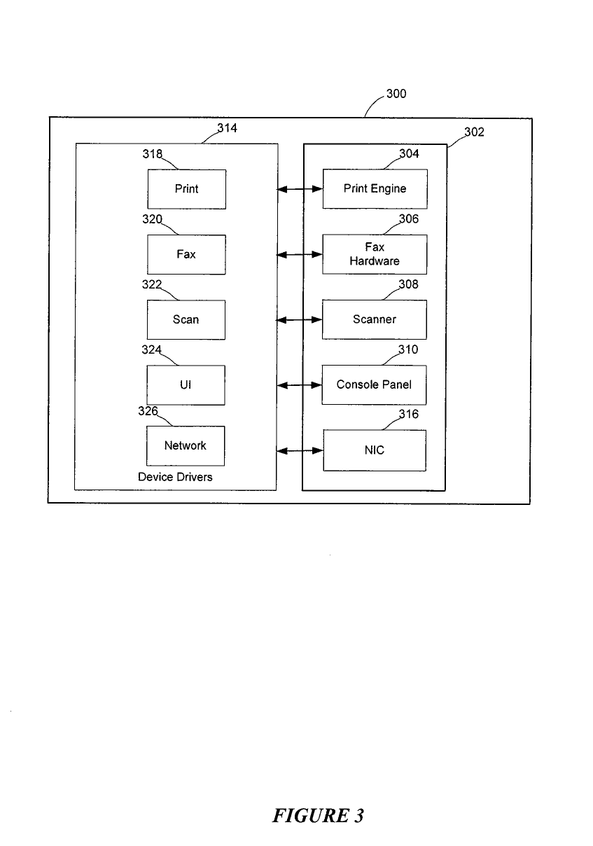

In accordance with the preferred embodiment of the subject application, the remote document processing device 104 and the local document processing device 112 are representative of a plurality of such document processing devices constituting a distributed document processing system. Preferably, this document processing system enables users to request document processing operations from any one or more of the document processing devices connected thereto. According to one aspect of the subject application, an associated user is able to log into the distributed document processing system via any one or more of the associated document processing devices and request the performance of a document processing operation. The skilled artisan will appreciate that such a system is capable of performing such document processing services based upon payment of costs associated therewith. In accordance with one aspect of the subject application, each document processing device of the distributed document processing system is located in a different geographical location, thereby enabling a user to access the system from a plurality of different locations. The functioning of the document processing devices 104, 112 will be more fully explained below with respect to FIG. 2 and FIG. 3.

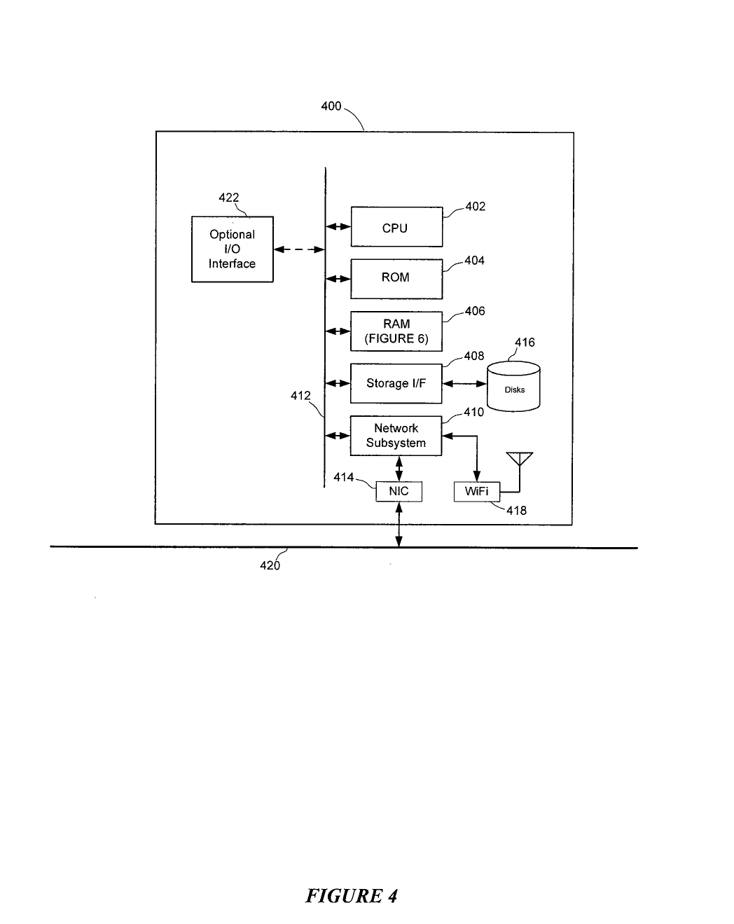

The system 100 illustrated in FIG. 1 further includes a backend component, shown as a backend server 120, communicatively coupled to the computer network 102 and adapted to provide document storage functions to users associated with the distributed document processing system. The backend server 120 is capable of implementation as any hardware, software, or suitable combination thereof, able to perform the functions described hereinafter. Preferably, the backend server 120 is communicatively coupled to the computer network 102 via a suitable communications link 124. As will be understood by those skilled in the art, the communications link 124 is suitably adapted to provide secure data communications between the backend server 120, the document processing devices 104, 112, or other devices associated with the distributed document processing system. The functioning of the backend server 120 is more fully explained in detail below with respect to FIG. 4.

Communicatively coupled to the backend server 120 is a data storage device 122, representative of a document processing queue. In accordance with the preferred embodiment of the subject application, the data storage device 122 is any mass storage device known in the art including, for example and without limitation, magnetic storage drives, a hard disk drive, optical storage devices, flash memory devices, or any suitable combination thereof. In the preferred embodiment, the data storage device 122 is suitably adapted to store document data, image data, electronic database data, or the like. Preferably, the document processing queue on the data storage device 122 is capable of storing partially rendered electronic documents. It will be appreciated by those skilled in the art that while illustrated in FIG. 1 as being a separate component of the system 100, the data storage device 122 is capable of being implemented as internal storage component of the backend server 120, or the like, such as, for example and without limitation, an internal hard disk drive, or the like.

The system 100 illustrated in FIG. 1 further depicts a first user device 126, in data communication with the local document processing device 112 via a communications link 128. It will be appreciated by those skilled in the art that the first user device 126 is shown in FIG. 1 as a laptop computer for illustration purposes only. As will be understood by those skilled in the art, the first user device 126 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 128 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the first user device 126 is suitably adapted to generate and transmit electronic documents, document processing instructions, job processing requests, user interface modifications, upgrades, updates, personalization data, or the like, to the local document processing device 112, or the like. Although shown as directly connected to the local document processing device 112, the skilled artisan will appreciate that the first user device 126 is capable of communication with the local document processing device 112 via a suitable communications link (not shown) to the computer network 102. The first user device 126 is suitably adapted to establish a connection to the distributed document processing system via a thin client interface resident thereon, a web browser, or the like.

In addition to the first user device 126, the system 100 of FIG. 1 further includes at least one additional user device, shown as the second user device 130, communicatively coupled to the computer network 102 via a communications link 132. It will be understood by those skilled in the art that the second user device 130 is shown in FIG. 1 as a laptop computer for illustration purposes only. As will be appreciated by those skilled in the art, the second user device 130 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 132 is any suitable channel of data communications known in the art including, but not limited to wireless communications, for example and without limitation, a proprietary communications network, the public switched telephone network, infrared, WiMax, Bluetooth, 802.11a, 802.11b, 802.11g, 802.11(x), optical, or any suitable wireless data transmission system, or wired communications known in the art. Preferably, the second user device 130 is suitably adapted to generate and transmit electronic documents, document processing instructions, job processing requests, user interface modifications, upgrades, updates, personalization data, or the like, to any one of the document processing devices 104, 112 coupled to the computer network 102. The second user device 130 is suitably adapted to establish a connection to the distributed document processing system via a thin client interface resident thereon, a web browser, or the like.

Turning now to FIG. 2, illustrated is a representative architecture of a suitable device 200 on which operations of the subject system 100 are completed. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the server 200.

Also included in the server 200 is random access memory 206, suitably formed of dynamic random access memory, static random access memory, or any other suitable, addressable memory system. Random access memory provides a storage area for data instructions associated with applications and data handling accomplished by processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. Network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with the bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

Document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine 302 also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable server 400 (shown in FIG. 1 as the backend server 120) on which operations of the subject system 100 are completed. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration, and other routines or data used for operation of the server 400.

Also included in the server 400 is random access memory 406, suitably formed of dynamic random access memory, static random access memory, or any other suitable, addressable memory system. Random access memory provides a storage area for data instructions associated with applications and data handling accomplished by processor 402.

A storage interface 408 suitably provides a mechanism for volatile, bulk or long term storage of data associated with the server 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the server 400 to communicate to other devices. Network interface subsystem 410 suitably interfaces with one or more connections with external devices to the server 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 414 is interconnected for data interchange via a physical network 420, suitably comprised of a local area network, wide area network, or a combination thereof.

Data communication between the processor 402, read only memory 404, random access memory 406, storage interface 408 and network subsystem 410 is suitably accomplished via a bus data transfer mechanism, such as illustrated by bus 412.

Suitable executable instructions on the server 400 facilitate communication with a plurality of external devices, such as workstations, document processing devices, other servers, or the like. While, in operation, a typical server operates autonomously, it is to be appreciated that direct control by a local user is sometimes desirable, and is suitably accomplished via an optional input/output interface 422 as will be appreciated by one of ordinary skill in the art.

In operation, an electronic document is first routed to a document processing queue that is accessible by one or more document processing devices via a computer network. A job processing request is then received from an associated user via a user interface. The job processing request preferably includes a request to commence processing of the electronic document stored in the queue at a selected document processing device. The job processing request is then communicated to the document processing queue, which functions to release the document from the queue. The released document is then communicated, via the computer network, from the queue to the selected document processing device upon receipt of the job processing request.

In accordance with one example embodiment of the subject application, an associated user is capable of accessing the system 100 via the first user device 126 in data communication with the local document processing device 112. It will be appreciated by those skilled in the art that the first user device 126 suitably includes a software component, such as a print driver, suitably adapted to generate a partially rendered electronic document, e.g., a page description language document, POSTSCRIPT file, or the like. Thus, when a user desires to produce a hardcopy of an electronic document, the user, via the first user device 126 opens the electronic document, or creates an electronic document, within a given software application. The user then initiates a print operation, wherein the first user device 126 prompts the user to select a suitable printer driver. The user is then prompted to select corresponding print options by the printer driver.

The print driver then prompts the user to log onto the distributed document processing system via any suitable means. Preferably, the first user device 126 is in data communication via a wireless communications link 128 with the local document processing device 112, which thereby facilitates connection to the distributed document processing system via the computer network 102. The skilled artisan will appreciate that such log on is accomplished via a suitable user interface operative on the first user device 126. Upon committal by the user of the print operation, the distributed document processing system accepts the print job request, whereupon the printer driver renders the selected electronic document into a page description language format, e.g., POSTSCRIPT format, or the like. This electronic document rendered in the appropriate format is then uploaded to the backend server 120 via the computer network 102. That is, the first user device 126 transmits the electronic document to the local document processing device 112 via the communications link 128. As the local document processing device 112 is communicatively coupled to the computer network 102, the local document processing device transfers this partially rendered electronic document to the backend server 120 via communications links 118 and 124. The uploaded document is then transferred to the document processing queue resident on the backend server 120 in association with a document identifier and the user identification data, i.e., the user logon information.

The user then approaches any document processing device 104 or 112 participating in the distributed document processing system. For purposes of example, the user approaches the local document processing device 112 and, via the associated user interface 114, logs onto the distributed document processing system. Preferably, the user provides identification data enabling the document processing device 112 to verify the identity of the user. This data is then transmitted, via the computer network 102, to the backend server 120 for retrieval of document identification data corresponding to those documents resident in the document processing queue. The local document processing device 112 then receives a listing of electronic documents stored in the document processing queue associated with the requesting user. This listing is then displayed to the user via the associated user interface 114.

The user then selects one of the electronic documents using the associated user interface 114. The local document processing device 112 submits a document retrieval request from the backend server 120, which retrieves the selected electronic document from the document processing queue and returns the document to the requesting local document processing device 112 via the computer network 102. The user is then prompted, via the associated user interface 114, to select print options, e.g., number of copies, color, media type, duplex, finishing options, or the like. The controller 116, or other component, of the local document processing device 112 then calculates any costs associated with the performance of the document processing operation requested by the user. The skilled artisan will appreciate that varying options, size, number of copies, and the like, are suitably used to determine the appropriate costs associated with performing the requested document processing operation. The costs are then displayed to the user via the associated user interface 114, whereupon the user is prompted to select a payment method. Suitable payment methods include, for example and without limitation, credit card, prepaid account, currency, prepaid card, or the like. The user then submits the payment for the requested operation using the method previously specified. Upon confirmation of the receipt of payment, the local document processing device 112 then performs the requested document processing operation.

In accordance with another example embodiment of the subject application, an associated user is capable of accessing the system 100 via the second user device 132 in data communication with the computer network 102. It will be appreciated by those skilled in the art that the second user device 130 suitably includes a software component, such as a web browser, suitably adapted to provide a user interface with the computer network 102. The skilled artisan will appreciate that any software component, known in the art, capable of providing a user with Internet connectivity is capable of being employed in accordance with the subject application. Suitable examples of such a web browser include, but are not limited to, INTERNET EXPLORER, NETSCAPE, OPTERA, MOZILLA, or the like. In accordance with one embodiment of the subject application, the distributed document processing system provides web-based access to the system via the computer network 102.

The user first logs into the web-portal by providing suitable identification data via the second user device 130. One or more documents are then uploaded from the second user device 130 to the document processing queue of the backend server 120 via the computer network 102. The skilled artisan will appreciate that the subject application is capable of implementing a variety of security protocols, thereby enabling the secure transmission of login data, electronic documents, payment data, and the like via the computer network 102. The user is then prompted to select print options associated with a desired document processing operation to be performed on one or more of the documents uploaded to the backend server 120. Preferably, the electronic documents uploaded to the document processing queue of the backend server 120 are in a suitable page description language format. However, the skilled artisan will appreciate that other formats, such as the original file format, are equally capable of being processed in accordance with the subject application. The user then commits the document processing request, i.e., job, to the distributed document processing system via the second user device 130. Upon acceptance of the requested document processing operation, the backend server 120 stores the received electronic document or documents in document processing queue associated therewith, wherein the document or documents are held.

The user is then able to exit the web-portal interface established via the computer network 102 and the second user device 130 by logging off the distributed document processing system. The skilled artisan will appreciate that one or more electronic documents associated with the user are thus stored by the backend server 120 and thereby available for access by the user via any document processing device associated with the distributed document processing system.

When the user desires to complete a requested document processing operation, the user approaches any one of the document processing devices 104, 112 associated with the distributed document processing system. The user then logs onto the system via a user interface associated with the document processing device selected for completion of the requested document processing operation. For example, when the user selects the remote document processing device 104, the user provides identification data, such as a username and/or password, to the device 104 via the associated user interface 106. The skilled artisan will appreciate that the user is able to use any document processing device of the distributed document processing system, such as the local document processing device 112. Once the user is authenticated on the distributed document processing system, the selected document processing device 104 requests a listing of documents in the document queue from the backend server 120 associated with the user identification. The backend server 120 returns a listing of documents associated with the user identification to the requesting document processing device 104 via the computer network 102.

The returned listing is then displayed via the associated user interface 106, thereby prompting the user to select one or more documents resident in the document processing queue for further processing by the selected document processing device 104. The selected document, as determined by the user selection of the document identification contained in the listing, is then requested from the backend server 120 by the selected document processing device 104. The backend component 120 retrieves the selected document from the document processing queue and returns the retrieved document to the requesting device 104. The user is then prompted to selected print options, such as, for example and without limitation, finishing options, color, duplex, number of copies, or the like.

The controller 108, or other component, of the selected document processing device 104 then calculates any costs associated with the performance of the document processing operation requested by the user. The skilled artisan will appreciate that varying options, size, number of copies, and the like, are suitably used to determine the appropriate costs associated with performing the requested document processing operation. The costs are then displayed to the user via the associated user interface 114, whereupon the user is prompted to select a payment method. Suitable payment methods include, for example and without limitation, credit card, prepaid account, currency, prepaid card, or the like. The user then submits the payment for the requested operation using the method previously specified. Upon confirmation of the receipt of payment, the selected document processing device 104 then processes the retrieved electronic document and performs the requested document processing operation.

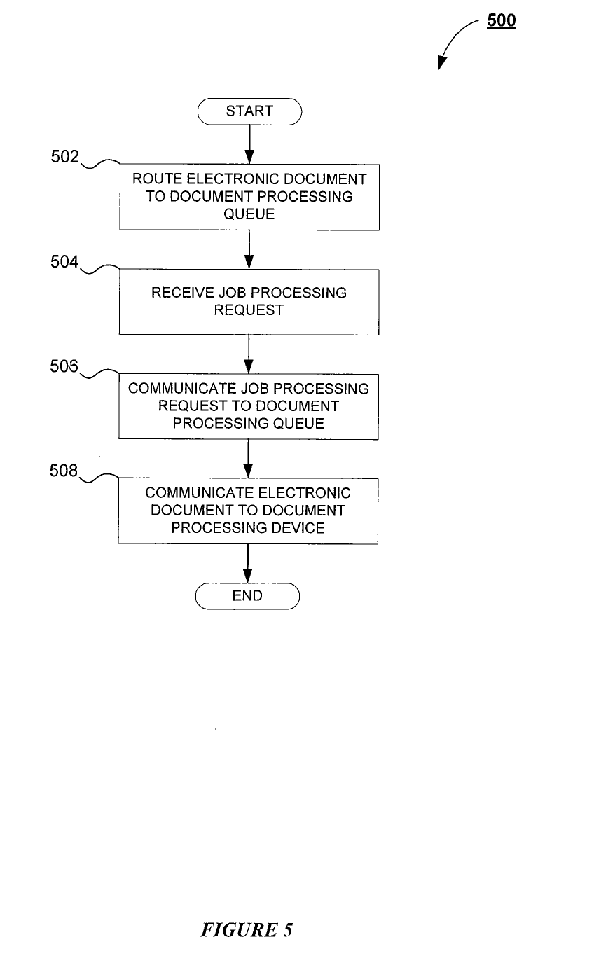

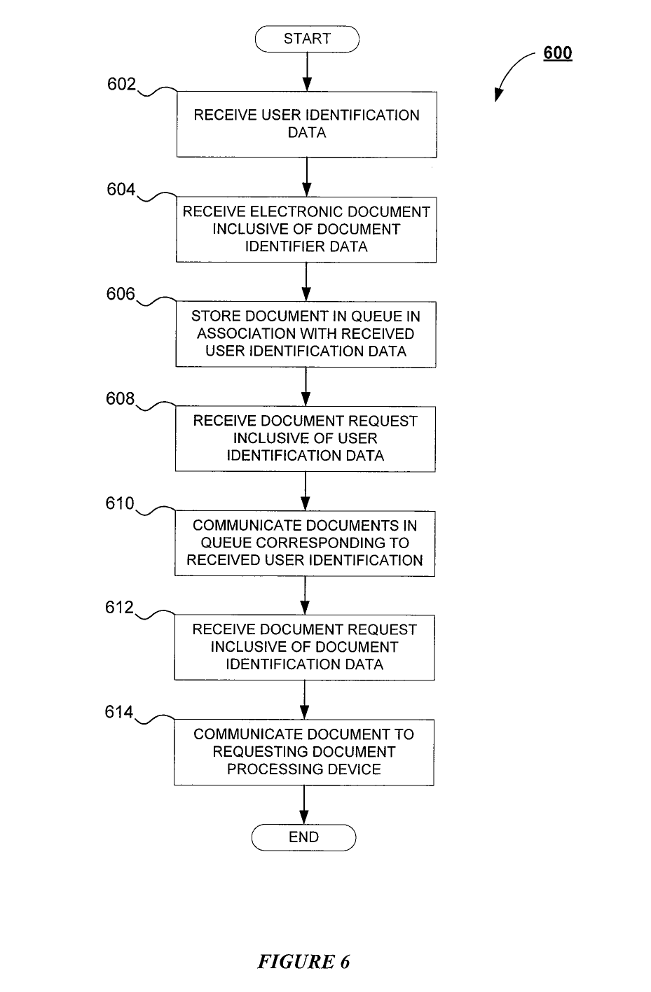

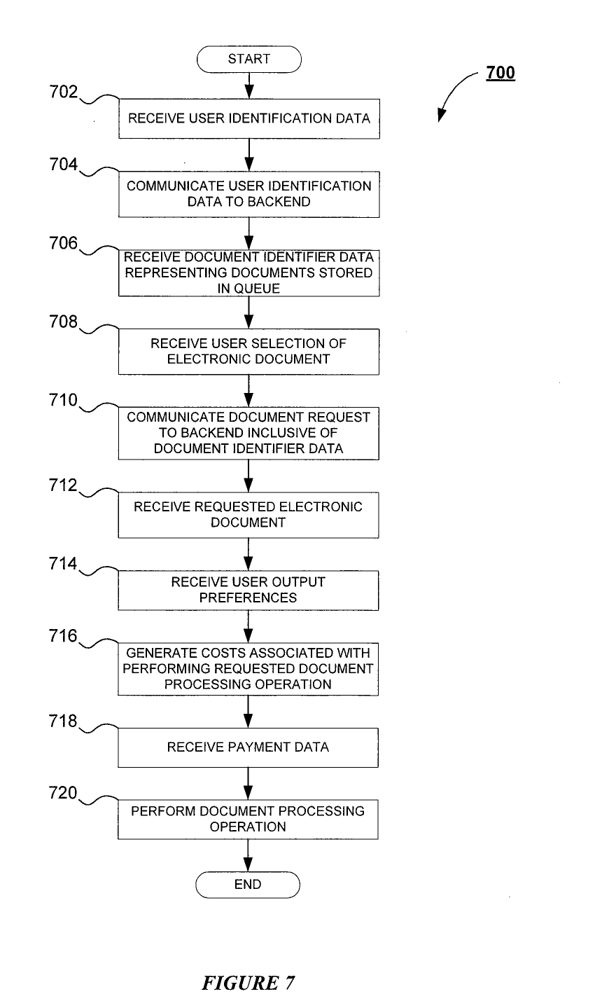

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5, FIG. 6, and FIG. 7. Turning now to FIG. 5, there is shown a flowchart 500 illustrating a method for routing electronic documents to an unspecified document processing device in accordance with the subject application. Beginning at step 502, an electronic document is routed to a document processing queue. Preferably, the document is routed via the computer network 102, to the document processing queue, which is accessible via the network 102 by the document processing devices 104, 112. At step 504 a job processing request is received from an associated user. In accordance with the subject application, the request is received from the associated user via a user interface associated with a selected document processing device. The request preferably includes an instruction from the user to commence processing, at a selected document processing device, the electronic document that is stored in the document processing queue. At step 506, the job processing request is communicated to the document processing queue to release the document from the queue. The electronic document is then communicated to the selected document processing device at step 508. Preferably, upon receipt of the job processing request, the electronic document is communicated from the document processing queue to the selected document processing device via the computer network 102.

Referring now to FIG. 6, there is shown a flowchart 600 illustrating a method for routing electronic documents to an unspecified document processing device from the server point of view in accordance with the subject application. The flowchart 600 illustrates a server side operation of the methodology of the subject application and thus is directed to the backend server 120. The method begins at step 602, whereupon the backend server 120 receives user identification data. Preferably, this user identification data is received from a user via a user interface associated with a data processing or document processing device communicatively coupled to the computer network 102. Suitable user identification data includes, for example and without limitation, a username and/or password, an alphanumeric account number, or the like. An electronic document inclusive of document identifier data is then received by the backend server 120 at step 604. Thereupon, the received electronic document is stored at step 606 in a document processing queue of the backend server 120 in association with the received user identification data and the document identification.

At step 608, the backend server 120 receives a document request from a document processing device over the computer network 102. Preferably, the document request includes identification data representative of a user at the document processing device initiating the document request. The backend server 120 then searches the queue for documents stored thereon associated with the received user identification data and communicates a listing of the documents to the requesting document processing device at step 610. The backend server 120 then receives a document request from the document processing device inclusive of a document identification of a selected document stored in the queue at step 612. Thereafter, the backend server 120 communicates the requested document from the document processing queue to the requesting document processing device at step 614. It will be appreciated by those skilled in the art that the subject methodology described in the flowchart 600 of FIG. 6 is capable of implementation wherein the user provides the document identification directly via a user interface associated with a selected document processing device, thereby bypassing the need for the server 120 to retrieve a complete listing of all documents associated with a specific user.

Turning now to FIG. 7, there is shown a flowchart 700 illustrating a method for routing electronic documents to an unspecified document processing device from a document processing device point of view in accordance with the subject application. The methodology described in FIG. 7 is applicable to any document processing device associated with the aforementioned distributed document processing system. For purposes of example only, reference will be made to the document processing device 104 with respect to FIG. 7, however any such document processing device is capable of implementation of the flowchart 700 of FIG. 7. Beginning at step 702, the document processing device 104 receives user identification data from an associated user via the user interface 106. Preferably, the user identification data includes, for example and without limitation, a username and/or password, an alphanumeric number, or other suitable identification known in the art. The user identification data is then communicated to the backend server 120 via the computer network 102 at step 704. Preferably this communication is accomplished via suitable security protocols to ensure data security, as are known in the art.

The document processing device 104 then receives document identification data representing those electronic documents stored in the document processing queue of the backend server 120 at step 706. The document processing device 104 then displays, via the associated user interface 106, the received document identification data to the user and receives selection data from the user of a desired electronic document for a requested document processing operation at step 708. At step 710, the document processing device 104 communicates, via the computer network 102, a document request to the backend server 120 for the desired electronic document. Preferably, the request includes the document identification data so as to enable the retrieval of a specific electronic document from the document processing queue.

At step 712, the document processing device 104 receives the requested electronic document from the backend server 120 via the computer network 102. The user is then prompted, via the associated user interface 106 for output preference selection, which is received from the user by the document processing device 104 at step 714. The skilled artisan will appreciate that suitable output preference selections include, for example and without limitation, output media, color, number of copies, duplex/simplex output, transmission type, or the like. The document processing device 104 then generates, at step 716, costs associated with performing the requested document processing operation. These costs are then displayed to the user via the associated user interface 106, prompting the user to select a desired payment method, such as, for example and without limitation, credit card, currency, prepaid card, prepaid account, or the like. At step 718 the document processing device 104 receives payment data corresponding to a payment for the costs associated with the requested document processing operation. Upon the receipt and confirmation of the payment data, the document processing device 104 performs the requested document processing operation on the retrieved electronic document at step 720.

It will be appreciated by those skilled in the art that the subject methodology described in the flowchart 700 of FIG. 7 is capable of implementation wherein the user provides the document identification directly via a user interface associated with a selected document processing device, thereby bypassing the need for the server 120 to retrieve a complete listing of all documents associated with a specific user. Other implementations in accordance with the method of the subject application will become apparent to those skilled in the art in conjunction with the methodologies described in FIG. 6 and FIG. 7.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for routing electronic documents to an unspecified document processing device comprising:
means adapted for routing an electronic document to a document processing queue accessible by each of a plurality of document processing devices in network communication therewith;
user interface means adapted for receiving a job processing request from an associated user to commence processing of the electronic document stored in the document processing queue at a document processing device selected from the plurality thereof;
means adapted for communicating data representative of a received job processing request to commence a release of the electronic document from the document processing queue; and
means adapted for communicating the electronic document via an associated network to the selected document processing device upon receipt of a job processing request.

2. The system for routing electronic documents to an unspecified document processing device of claim 1 wherein the user interface means is comprised of a thin client on an associated networked data processing device.

3. The system for routing electronic documents to an unspecified document processing device of claim 1 wherein the user interface is associated with the selected document processing device.

4. The system for routing electronic documents to an unspecified document processing device of claim 1 further comprising:
means adapted for receiving identifier data representative of an identity of the associated user; and
means adapted for generating document identifier data representative of the electronic document on the user interface.

5. The system for routing electronic documents to an unspecified document processing device of claim 4 further comprising means:
means adapted for displaying, on the user interface, cost data associated with a cost of a document processing operation on the electronic document;
means adapted for receiving payment data representative of a payment for the document processing operation; and
means adapted for commencing processing of the electronic document on the selected document processing device upon receipt of payment data.

6. The system for routing electronic documents to an unspecified document processing device of claim 5 wherein the payment data is obtained in accordance with a credit card swipe completed at the selected document processing device.

7. A method for routing electronic documents to an unspecified document processing device comprising the steps of:
routing an electronic document to a document processing queue accessible by each of a plurality of document processing devices in network communication therewith;
receiving a job processing request, via a user interface, from an associated user to commence processing of the electronic document stored in the document processing queue at a document processing device selected from the plurality thereof;
communicating data representative of a received job processing request to commence a release of the electronic document from the document processing queue; and
communicating the electronic document via an associated network to the selected document processing device upon receipt of a job processing request.

8. The method for routing electronic documents to an unspecified document processing device of claim 7 wherein the job processing request is received via a user interface of an associated networked data processing device.

9. The method for routing electronic documents to an unspecified document processing device of claim 7 wherein the job processing request is received via a user interface associated with the selected document processing device.

10. The method for routing electronic documents to an unspecified document processing device of claim 7 further comprising the steps of:
receiving identifier data representative of an identity of the associated user; and
generating document identifier data representative of the electronic document on an associated user interface.

11. The method for routing electronic documents to an unspecified document processing device of claim 10 further comprising the steps of:
displaying, via an associated user interface, cost data associated with a cost of a document processing operation on the electronic document;
receiving payment data representative of a payment for the document processing operation; and
commencing processing of the electronic document on the selected document processing device upon receipt of payment data.

12. The method for routing electronic documents to an unspecified document processing device of claim 11 wherein the payment data is obtained in accordance with a credit card swipe completed at the selected document processing device.

13. A computer-implemented method for routing electronic documents to an unspecified document processing device comprising the steps of:
routing an electronic document to a document processing queue accessible by each of a plurality of document processing devices in network communication therewith;
receiving a job processing request, via a user interface, from an associated user to commence processing of the electronic document stored in the document processing queue at a document processing device selected from the plurality thereof;
communicating data representative of a received job processing request to commence a release of the electronic document from the document processing queue; and
communicating the electronic document via an associated network to the selected document processing device upon receipt of a job processing request.

14. The computer-implemented method for routing electronic documents to an unspecified document processing device of claim 13 wherein the job processing request is received via a user interface of an associated networked data processing device.

15. The computer-implemented method for routing electronic documents to an unspecified document processing device of claim 13 wherein the job processing request is received via a user interface associated with the selected document processing device.

16. The computer-implemented method for routing electronic documents to an unspecified document processing device of claim 13 further comprising the steps of:
receiving identifier data representative of an identity of the associated user; and
generating document identifier data representative of the electronic document on an associated user interface.

17. The computer-implemented method for routing electronic documents to an unspecified document processing device of claim 16 further comprising the steps of:
displaying, via an associated user interface, cost data associated with a cost of a document processing operation on the electronic document;
receiving payment data representative of a payment for the document processing operation; and
commencing processing of the electronic document on the selected document processing device upon receipt of payment data.

18. The computer-implemented method for routing electronic documents to an unspecified document processing device of claim 17 wherein the payment data is obtained in accordance with a credit card swipe completed at the selected document processing device.
